(19) United States
(12) Patent Application Publication
(10) Pub. No.: US 2019/0220220 A1
(43) Pub. Date: Jul. 18, 2019

(54) DATA STORAGE DEVICE, OPERATING METHOD THEREOF AND NONVOLATILE MEMORY DEVICE

(71) Applicant: SK hynix Inc., Icheon-si Gyeonggi-do (KR)

(72) Inventors: Ki Sung KIM, Suwon-si Gyeonggi-do (KR); Keun Hyung KIM, Icheon-si Gyeonggi-do (KR)

(73) Assignee: SK hynix Inc., Icheon-si Gyeonggi-do (KR)

(21) Appl. No.: 16/153,208

(22) Filed: Oct. 5, 2018

(30) Foreign Application Priority Data
Jan. 16, 2018 (KR) 10-2018-0005416

(51) Int. Cl. G06F 3/06

(52) U.S. Cl. CPC G06F 3/0652; G06F 3/0604; G06F 3/0679

(57) ABSTRACT

A nonvolatile memory device and a method of operating the same include a memory block, a controller interface unit, and a memory control unit. The nonvolatile memory device is configured to receive through the controller interface unit from a controller an erase command for performing an erase operation on the memory block. The memory control unit configured to perform the erase operation on the memory block in response to the nonvolatile memory device receiving the erase command. When the nonvolatile memory device receives an erase suspend command through the controller interface unit from the controller during the erase operation, the memory control unit continues performing the erase operation up to a specified time after the erase suspend command is received before suspending the erase operation in response to receiving the erase suspend command.

### CROSS-REFERENCES TO RELATED APPLICATION

The present application claims priority under 35 U.S.C. §119(a) to Korean application number 10-2018-0005416, filed on Jan. 16, 2018, in the Korean Intellectual Property Office, which is incorporated herein by reference in its entirety.

### BACKGROUND

### 1. Technical Field

Various embodiments generally relate to a data storage device, and more particularly, to a data storage device including a nonvolatile memory device.

### 2. Related Art

A data storage device may be configured to store data received from an external device, in response to a write request from the external device. Also, the data storage device may be configured to provide stored data to the external device, in response to a read request from the external device. External electronic devices capable of processing data include, for example, computers, digital cameras, and mobile phones. The data storage device may be integrated with the external device or may be manufactured separate from and operably coupled to the external device.

A data storage device using a memory device has an advantage in that because there are no moving mechanical parts, stability and durability are favorable, and power consumption is low. However, such a data storage device can have undesirable latency issues.

### SUMMARY

In accordance with the present teachings is a nonvolatile memory device including a memory block, a controller interface unit, and a memory control unit. The nonvolatile memory device may be configured to receive through the controller interface unit from a controller an erase command for performing an erase operation on the memory block. The memory control unit may be configured to perform the erase operation on the memory block in response to the nonvolatile memory device receiving the erase command. When the nonvolatile memory device receives an erase suspend command through the controller interface unit from the controller during the erase operation, the memory control unit may continue performing the erase operation up to a specified time.

Also in accordance with the present teachings is a data storage device including a controller and a nonvolatile memory device. The nonvolatile memory device may be configured to perform an erase operation of data in response to receiving an erase command from the controller and configured to suspend the erase operation in response to receiving an erase suspend command from the controller. The nonvolatile memory device may continue to perform the erase operation up to a specified time after receiving the erase suspend command.

Further in accordance with the present teachings is a method for operating a data storage device. The method may include performing an erase operation for stored data in a nonvolatile memory device of the data storage device. The method may additionally include receiving, from a controller, an erase suspend command for suspending the erase operation being performed and determining a specified time up to which the erase operation continues to be performed after receiving erase suspend command.

### BRIEF DESCRIPTION OF THE DRAWINGS

FIG. 1 shows a block diagram illustrating a nonvolatile memory device, in accordance with an embodiment of the present teachings.

FIG. 2 shows graphs illustrating conventional relationships between time and an erase voltage in cases when an erase suspend command is received while performing an erase operation.

FIG. 3 shows graphs illustrating relationships between time and an erase voltage in cases when an erase suspend command is received while performing an erase operation, in accordance with an embodiment of the present teachings.

FIG. 4 shows a block diagram illustrating a data storage device, in accordance with an embodiment of the present teachings.

FIG. 5 shows a flowchart illustrating a method for operating a data storage device, in accordance with an embodiment of the present teachings.

FIG. 6 shows a flowchart illustrating a method for operating a data storage device, in accordance with an embodiment of the present teachings.

FIG. 7 shows a block diagram illustrating a data processing system including a solid state drive, in accordance with an embodiment of the present teachings.

FIG. 8 shows a diagram illustrating a a data processing system including a data storage device, in accordance with an embodiment of the present teachings.

FIG. 9 shows a diagram illustrating a data processing system including a data storage device, in accordance with an embodiment of the present teachings.

FIG. 10 shows a diagram illustrating a network system including a data storage device, in accordance with an embodiment of the present teachings.

FIG. 11 shows a block diagram illustrating a a nonvolatile memory device included in a data storage device, in accordance with an embodiment of the present teachings.

### DETAILED DESCRIPTION

Various advantages, features, and methods consistent with the present teachings will become more apparent after reading the descriptions for presented embodiments taken in conjunction with the drawings. The present teachings may also be embodied in different forms, which due to limited space constraints, are not all described herein. However, persons skilled in the art will understand that other embodiments, consistent with the spirit of the present teachings and in accordance with the claims presented below, are possible.

It is to be understood that embodiments of the present teachings are not limited to the particular embodiments presented herein. Further, included figures are not necessarily drawn to scale. In some instances relative proportions may be exaggerated in order to more clearly depict certain features of the present teachings.

While particular terminology is used herein to describe particular embodiments, such terminology is not intended to generally limit the scope of the present teachings.

As used herein, the terms “and” and “or” include any and all combinations of one or more listed items associated with either term. It will be understood that when a first element is referred to as being “on,” “connected to,” or “coupled to” a second element, the first element may be directly on, directly connected to, or directly coupled to the second element, or intervening elements may be present between the first and second elements. As used herein, a singular form is intended to also include plural forms with respect to alternate embodiments, unless the context clearly indicates otherwise. It will be further understood that the terms “include,” “includes,” and “including,” when used in this specification, specify the presence of at least one stated feature, step, operation, and/or element, but do not preclude the presence or addition of one or more other features, steps, operations, and/or elements.

Various embodiments are directed to a data storage device which stores a progressed erase operation upon receiving a suspend command while performing the erase operation. The progressed erase operation is later resumed based on the stored data, thereby improving latency by not having to repeat an already performed portion of the progressed erase operation. This results in improved quality of service (QoS), for example, given a data storage device including a nonvolatile memory device. A progressed operation, as used herein, means that a portion of the operation has been performed without the operation being completed.

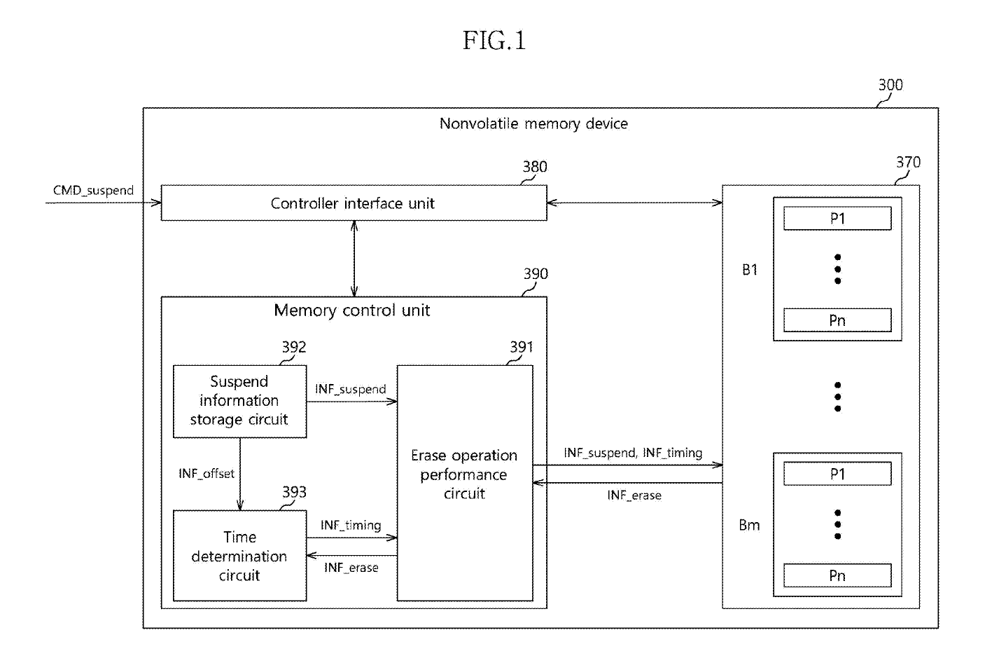

FIG. 1 shows a block diagram illustrating a nonvolatile memory device 300, in accordance with an embodiment of the present teachings.

The nonvolatile memory device 300 may include a memory cell region 370, a controller interface unit 380, and a memory control unit 390.

The memory cell region 370 may include a plurality of memory blocks B1 to Bm, and each of the memory blocks B1 to Bm may include a plurality of pages P1 to Pn. From an operational viewpoint or a physical (or structural) viewpoint, the memory cells included in the memory cell region 370 may be configured as a hierarchical memory cell set or a memory cell unit. For example, memory cells which are coupled to the same word line and are to be read and written (or programmed) simultaneously may be configured as a page. In the following descriptions, for convenience of explanation, memory cells configured as a page will be referred to as a “page.” Also, memory cells to be erased simultaneously may be configured as a memory block.

The controller interface unit 380 may receive control signals from a controller. The control signals may include a command, an address, a control signal, a suspend signal, and so forth for controlling the nonvolatile memory device 300. The controller interface unit 380 may be provided with data from the controller or may provide data to the controller.

The memory control unit 390 may be configured to perform an erase operation for the memory blocks B1 to Bm. The memory control unit 390 may include an erase operation performance circuit 391, a suspend information storage circuit 392, and a time determination circuit 393.

The erase operation performance circuit 391 may control the erase operation to be performed in the memory cell region 370 of the nonvolatile memory device 300. In detail, when an erase command is received from the controller, the erase operation performance circuit 391 may control, through a signal for starting the erase operation, the start of the erase operation to be performed in the memory cell region 370. When an erase suspend command CMD_suspend is received from the controller, the erase operation performance circuit 391 may control, through a suspend information INF_suspend, the suspension of the erase operation.

The suspend information storage circuit 392 may be configured with random access memory, such as a dynamic random access memory (DRAM) or static random access memory (SRAM). The suspend information storage circuit 392 may store firmware (FW) which is driven by the memory control unit 390. The suspend information storage circuit 392 may store suspend information INF_suspend on a part, such as an initial part, of the erase operation that is performed up to a specified time at which point the erase operation is suspended. That is to say, the suspend information storage circuit 392 may operate as the working memory of the memory control unit 390. The suspend information storage circuit 392 may store offset information INF_offset. The offset information INF_offset may be used as information for determining the specified time at which the erase operation is to be suspended, when the erase suspend command CMD_suspend is received from the controller while the erase operation is being performed.

The time determination circuit 393 may be configured to be a micro control unit (MCU) or a central processing unit (CPU). The time determination circuit 393 may determine a time when the erase suspend command CMD_suspend transmitted from the controller is received, may select a time among one or more times calculated from a start time when an erase voltage is first applied, according to one or more preset offset values, and may determine the selected time as the specified time.

According to an embodiment, when the controller outputs the erase suspend command CMD_suspend for the erase operation, the nonvolatile memory device 300 may receive the suspend command CMD_suspend through the controller interface unit 380. After the erase suspend command CMD_suspend is received, the erase operation performance circuit 391 may receive erase progress information INF_erase including a degree of progress for the erase operation that is being performed in the memory cell region 370. The time determination circuit 393 may receive the erase progress information INF_erase from the erase operation performance circuit 391 and may receive the offset information INF_offset from the suspend information storage circuit 392. The time determination circuit 393 may determine the specified time as a time at which the erase operation is to be suspended, based on the erase progress information INF_erase and the offset information INF_offset. The time determination circuit 393 may also transmit to the erase operation performance circuit 391 time information INF_timing as information on the specified time. The erase operation performance circuit 391 may control, based on the received time information INF_timing, the erase operation being performed in the memory cell region 370, which is to be suspended at the specified time.

According to an embodiment, when the erase operation is resumed after being suspended, the erase operation performance circuit 391 may receive the suspend information INF_suspend stored in the suspend information storage circuit 392. The suspend information INF_suspend may include information on the part, such as an initial part, of the erase operation that is performed to the specified time. The erase operation performance circuit 391 may control the memory cell region 370 based on the received suspend information INF_suspend such that the erase operation is resumed rather than repeated. For one embodiment, a remaining part, different from the initial part, of the erase operation is performed when the erase operation is resumed such that the entire erase operation, with respect to an erase command, is completed in two parts. In other embodiments, an erase operation may be suspended and resumed multiple times such that two or more different parts of the erase operation collectively represent a completed erase operation in accordance with a received erase command.

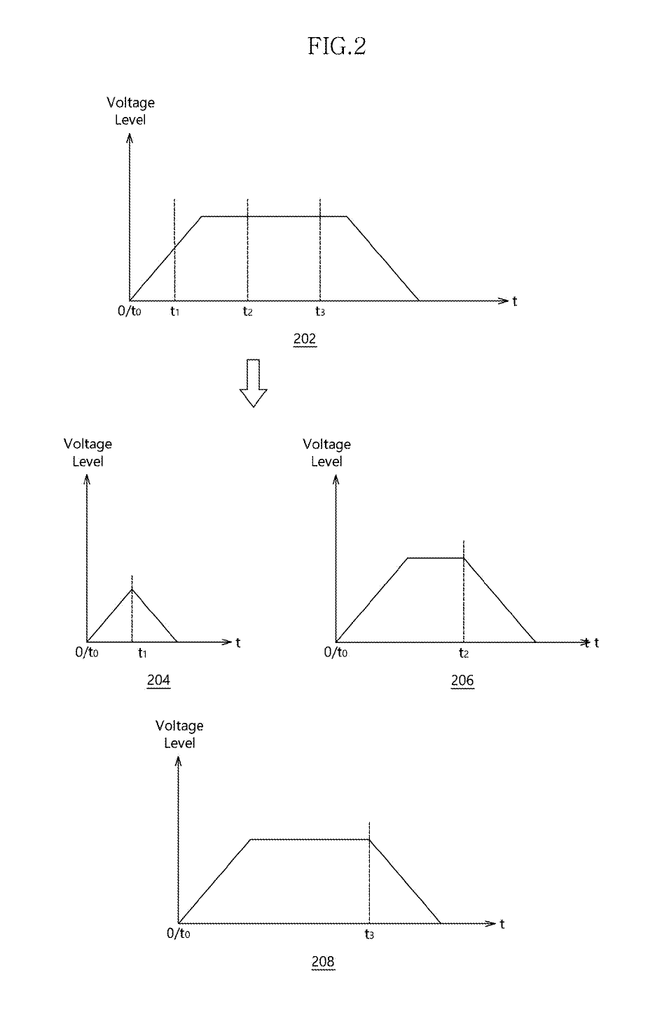

FIG. 2 shows four graphs 202, 204, 206, 208 illustrating relationships between time and an erase voltage in cases when an erase suspend command is received while performing an erase operation in a data storage device. An erase operation may be performed as an erase voltage is applied.

Referring to FIG. 2, an erase operation may be performed as an erase voltage is applied. While an erase voltage may be set to a plurality of voltage levels and be applied a multitude of times, it is illustrated for the sake of convenience in explanation that one erase voltage is applied through a period.

Referring to graph 202 of FIG. 2, an erase suspend command is received at a first time t1, a second time t2, or a third time t3 with respect to a time t0 when an erase voltage is applied. The erase operation being performed starts to be suspended at the time t1, t2, or t3 when the erase suspend command is received. This is illustrated by graphs 204, 206, and 208. In particular, the graph 204 shows the erase suspend command being received and the erase operation being suspended at the time t1. The graph 206 shows the erase suspend command being received and the erase operation being suspended at the time t2. The graph 208 shows the erase suspend command being received and the erase operation being suspended at the time t3. Often, a duration of time for which an erase operation is suspended is short. Further, a substantial portion of the erase operation may have been completed at the time the erase operation is suspended. In resuming the erase operation, the erase operation is started again from its beginning. Thus, a potentially substantial portion of the erase operation may be repeated. This consumes time, increases latency, and reduces quality of service (QoS).

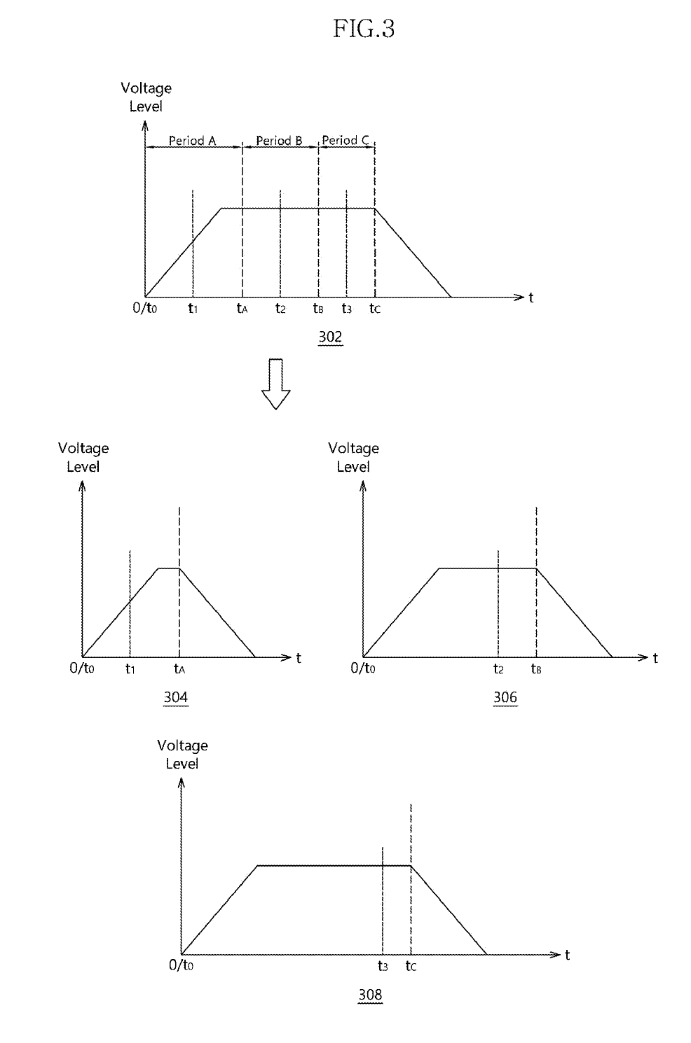

FIG. 3 shows graphs 302, 304, 306, 308 illustrating relationships between time and an erase voltage in cases when an erase suspend command is received while performing an erase operation in a data storage device, in accordance with an embodiment of the present disclosure.

Referring to FIG. 3, the nonvolatile memory device 300 may suspend an erase operation after beginning the erase operation and performing the erase operation up to a specified time, when an erase suspend command is received from an external controller during the process of performing the erase operation. While an erase voltage may be set to a plurality of voltage levels and be applied a multitude of times, it is illustrated for convenience of explanation that one erase voltage is applied through a period.

The memory control unit 390 may perform the erase operation up to the specified time from a start time t0 at which the erase voltage is first applied. The specified time may be any one time selected among times tA, tB, and tC calculated from the start time t0 at which the erase voltage starts to be applied, according to one or more preset offset values. The specified time may be a time after the erase suspend command is received, among the times tA, tB, and tC. Graphs 204, 206, and 208 illustrate cases where the specified time is selected as the time tA, the time tB and the time tC, respectively. While it is assumed for convenience of explanation that the number of offset values and the number of times calculated according to the offset values is three, it is to not limited to this value. In other embodiments, the number of offset values and the number of times calculated according to the offset values might be any number or numbers greater than or equal to one.

In the case where the erase voltage is applied at t0 and the erase suspend command is received at a time t1 within a period A from t0 to tA, the erase operation is performed to the time tA, as indicated by graphs 302 and 304. In the case where the erase voltage is applied at t0 and the erase suspend command is received at a time t2 within a period B from tA to tB, the erase operation is performed to the time tB, as indicated by graphs 302 and 306. In the case where the erase voltage is applied at t0 and the erase suspend command is received at a time t3 within a period C from tB to tC, the erase operation is performed to the time tC, as indicated by graphs 302 and 308.

In the case where the erase suspend command is received after the time tC, the erase operation is not suspended within the duration of the applied erase voltage. In detail, after the erase voltage is applied, a verify voltage for verifying whether memory cells are erased or not may be applied. If it is determined as a result of applying the verify voltage that memory cells are completely erased, an erase voltage may be discontinued and the erase operation may be completed. According to an embodiment, if it is determined as a result of applying the verify voltage that memory cells are not completely erased, an erase voltage may again be applied after the erase suspending operation described above.

The memory control unit 390 of the nonvolatile memory device 300 may perform the remaining part of the erase operation, with the exception of the initial part of the erase operation that is performed up to the specified time, when the erase operation is resumed. In other words, in the case where the erase suspend command is received during the period A, the erase operation may be resumed from the time tA. In the case where the erase suspend command is received during the period B, the erase operation may be resumed from the time tB. In the case where the erase suspend command is received during the period C, the erase operation may be resumed from the time tC. If the erase suspend command is received after the time tC and memory cells are not completely erased by the applied erase voltage, the erase operation may be resumed at a time when an erase voltage is again applied.

For an embodiment, a method of erasing a portion of a nonvolatile memory device includes completing an erase operation in a plurality of parts, wherein at least two parts of the plurality of parts are separated in time by a delayed suspension of the erase operation, in response to receiving an erase suspend command, before resuming the erase operation.

While an erase voltage applied in an erase operation may be set to a plurality of voltage levels and may be applied a multitude of times, it is illustrated in FIG. 3 for convenience of explanation that one erase voltage is applied through a period. It is to be noted that a plurality of erase voltages may be applied in each period during which erase voltages are applied.

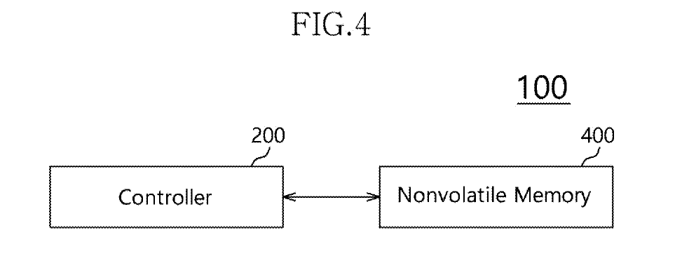

FIG. 4 shows a block diagram illustrating a data storage device 100, in accordance with an embodiment of the present teachings.

Referring to FIG. 4, the data storage device 100 may store data to be accessed by a host device (not shown), such as a mobile phone, an MP3 player, a laptop computer, a desktop computer, a gaming device, a TV, an in-vehicle infotainment system, and so forth. The data storage device 100 may be referred to as a memory system.

The data storage device 100 may be manufactured as any one of various kinds of storage devices according to a host interface transmission protocol. For example, the data storage device 100 may be configured as any one of various kinds of storage devices such as: a solid state drive (SSD); a multimedia card in the form of an MMC, an eMMC, an RS-MMC, or a micro-MMC; a secure digital card in the form of an SD, a mini-SD, or a micro-SD; a universal serial bus (USB) storage device; a universal flash storage (UFS) device; a Personal Computer Memory Card International Association (PCMCIA) card type storage device; a peripheral component interconnection (PCI) card type storage device; a PCI express (PCI-E) card type storage device; a compact flash (CF) card; a smart media card; a memory stick, and so forth.

The data storage device 100 may be manufactured as any one among various kinds of package types. For example, the data storage device 100 may be manufactured as any one of various kinds of package types such as a package-on-package (POP), a system-in-package (SIP), a system-on-chip (SOC), a multi-chip package (MCP), a chip-on-board (COB), a wafer-level fabricated package (WFP), and a wafer-level stack package (WSP).

The data storage device 100 may include a controller 200 and a nonvolatile memory device 400. For an embodiment, the nonvolatile memory device 400 represents the nonvolatile memory device 300 shown in FIG. 1.

The controller 200 may transmit an erase suspend command to the nonvolatile memory device 400 while an erase operation is being performed in the nonvolatile memory device 400.

The erase suspend command received from the controller 200 may include a write command. In the case where the erase suspend command including the write command is received and the erase operation is suspended according to described embodiments, data may be written from a time at which the erase operation is suspended.

The erase suspend command received from the controller 200 may include a read command. In the case where the erase suspend command including the read command is received and the erase operation is suspended according to described embodiments, the data stored in a page corresponding to a target address of the read command may be read from a time at which the erase operation is suspended.

The nonvolatile memory device 400 may perform the erase operation for data, based on the erase command from the controller 200. When the erase suspend command is received from the controller 200 while the erase operation is being performed, the nonvolatile memory device 400 may suspend the erase operation after continuing to perform the erase operation up to a specified time. The nonvolatile memory device 400 may be configured in substantially the same manner as the nonvolatile memory device 300 of FIG. 1.

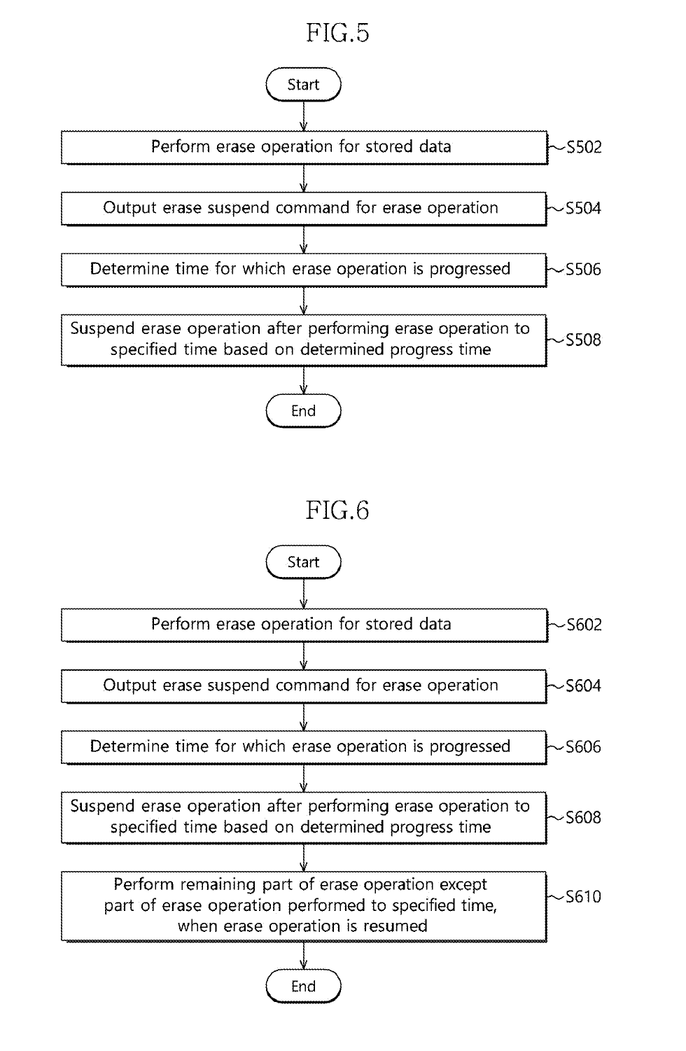

FIG. 5 shows a flowchart illustrating a method for operating a data storage device, in accordance with an embodiment of the present teachings.

Referring to FIGS. 4 and 5, the method includes performing S502 an erase operation for data stored in the nonvolatile memory device 300 and outputting S504 an erase suspend command for the erase operation from the controller 200. The method further includes determining S506, in response to the erase suspend command, a specified time up to which the erase operation is performed and suspending S508 the erase operation at the specified time. The specified time may be a time selected among one or more times calculated, according to one or more preset offset values, from a start time when an erase voltage is first applied. For an embodiment, the specified time may be the earliest selectable time after the erase suspend command is received.

FIG. 6 shows a flowchart illustrating a method for operating a data storage device, in accordance with another embodiment of the present teachings.

Referring to FIGS. 4 and 6, operations S602 S604, S606, and S608 of the method illustrated by FIG. 6 duplicate the operations S502, S504, S506, and S508, respectively, of the method illustrated by FIG. 5. The method illustrated by FIG. 6, however, further includes performing S610 the remaining part of the uncompleted erase operation, which was suspended in the nonvolatile memory device 300 at the specified time.

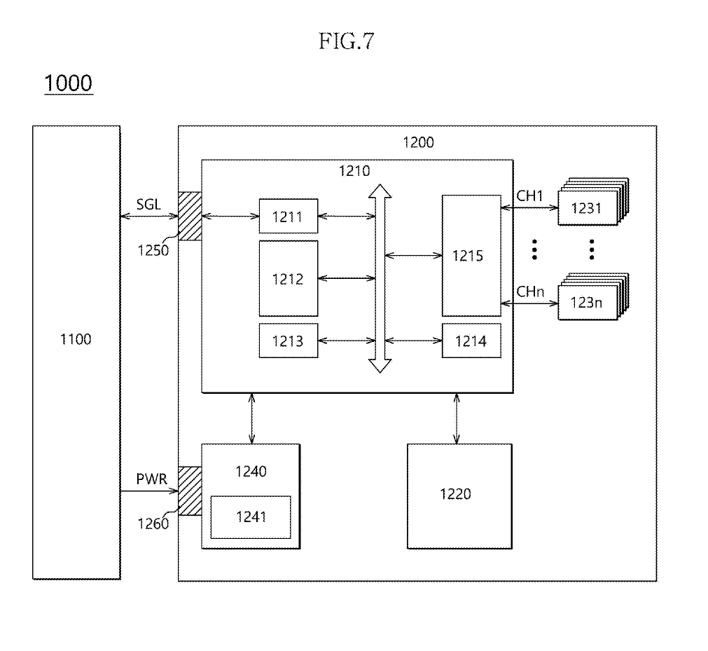

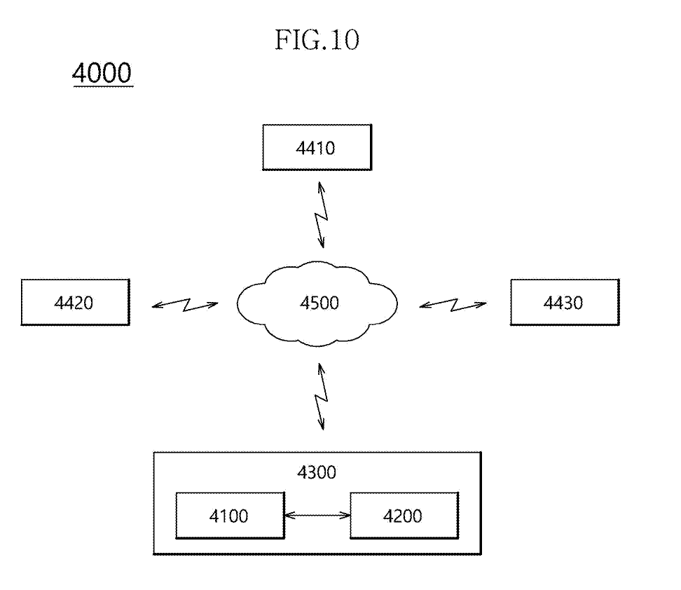

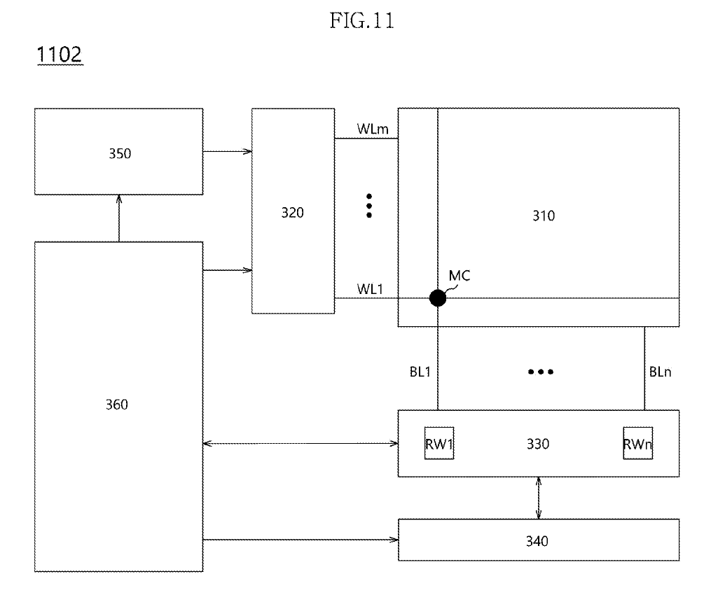

FIGS. 7 through 9 show data processing systems incorporating one or more nonvolatile memory devices in accordance with the present teachings. FIG. 10 shows a network system incorporating one or more nonvolatile memory devices in accordance with the present teachings. FIG. 11 shows a nonvolatile memory device in accordance with the present teachings.

FIG. 7 shows a diagram illustrating a data processing system 1000 including a solid state drive (SSD), in accordance with an embodiment of the present teachings. Referring to FIG. 7, the data processing system 1000 may include a host device 1100 and a solid state drive (SSD) 1200.

The SSD 1200 may include a controller 1210, a buffer memory device 1220, nonvolatile memory devices 1231 to 123n, a power supply 1240, a signal connector 1250, and a power connector 1260. For an embodiment, one or more nonvolatile memory devices 1231 to 123n represent the nonvolatile memory device 300 shown in FIG. 1.

The controller 1210 may control general operations of the SSD 1200. The controller 1210 may include a host interface unit 1211, a main control unit 1212, a random access memory 1213, an error correction code (ECC) unit 1214, and a memory interface unit 1215.

The host interface unit 1211 may exchange a signal SGL with the host device 1100 through the signal connector 1250. The signal SGL may include a command, an address, data, and so forth. The host interface unit 1211 may interface with the host device 1100 and the SSD 1200 according to a protocol of the host device 1100. For example, the host interface unit 1211 may communicate with the host device 1100 through any one of standard interface protocols, such as secure digital, universal serial bus (USB), multimedia card (MMC), embedded MMC (eMMC), personal computer memory card international association (PCMCIA), parallel advanced technology attachment (PATA), serial advanced technology attachment (SATA), small computer system interface (SCSI), serial attached SCSI (SAS), peripheral component interconnection (PCI), PCI express (PCI-E), and universal flash storage (UFS).

The main control unit 1212 may analyze and process a signal SGL inputted from the host device 1100. The main control unit 1212 may control operations of internal function blocks according to firmware or software for driving the SSD 1200. The random access memory 1213 may be used as a working memory for driving such firmware or software.

The error correction code (ECC) unit 1214 may generate the parity data of data to be transmitted to the nonvolatile memory devices 1231 to 123n. The generated parity data may be stored together with the data in the nonvolatile memory devices 1231 to 123n. The error correction code (ECC) unit 1214 may detect an error of the data read out from the nonvolatile memory devices 1231 to 123n, based on the parity data. If a detected error is within a correctable range, the error correction code (ECC) unit 1214 may correct the detected error.

The memory interface unit 1215 may provide control signals, such as commands and addresses, to the nonvolatile memory devices 1231 to 123n, according to the control of the main control unit 1212. Moreover, the memory interface unit 1215 may exchange data with the nonvolatile memory devices 1231 to 123n, according to the control of the main control unit 1212. For example, the memory interface unit 1215 may provide the data stored in the buffer memory device 1220 to the nonvolatile memory devices 1231 to 123n or provide the data read out from the nonvolatile memory devices 1231 to 123n to the buffer memory device 1220.

The buffer memory device 1220 may temporarily store data to be stored in the nonvolatile memory devices 1231 to 123n. Further, the buffer memory device 1220 may temporarily store the data read out from the nonvolatile memory devices 1231 to 123n. The data temporarily stored in the buffer memory device 1220 may be transmitted to the host device 1100 or the nonvolatile memory devices 1231 to 123n according to the control of the controller 1210.

The nonvolatile memory devices 1231 to 123n may be used as storage media of the SSD 1200. The nonvolatile memory devices 1231 to 123n may be coupled with the controller 1210 through a plurality of channels CH1 to CHn, respectively. One or more nonvolatile memory devices may be coupled to one channel. The nonvolatile memory devices coupled to each channel may be coupled to the same signal bus and data bus.

The power supply 1240 may provide power PWR, inputted through the power connector 1260, to the internal components of the SSD 1200. The power supply 1240 may include an auxiliary power supply 1241. The auxiliary power supply 1241 may supply power to allow the SSD 1200 to be normally terminated when a sudden power-off occurs. The auxiliary power supply 1241 may include large capacity capacitors.

The signal connector 1250 may be configured as various types of connectors depending on an interface scheme between the host device 1100 and the SSD 1200.

The power connector 1260 may be configured as various types of connectors depending on a power supply scheme of the host device 1100.

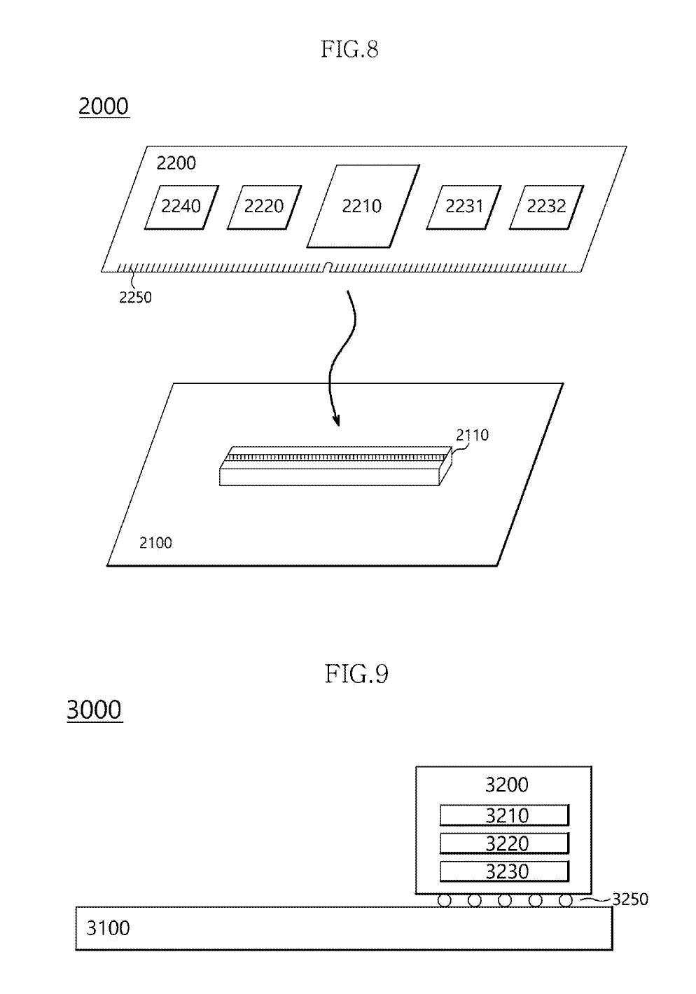

FIG. 8 shows a diagram illustrating a data processing system 2000 including a data storage device 2200, in accordance with an embodiment of the present teachings. Referring to FIG. 8, the data processing system 2000 may include a host device 2100 and the data storage device 2200.

The host device 2100 may be configured in the form of a board, such as a printed circuit board. Although not shown, the host device 2100 may include internal function blocks for performing the function of a host device.

The host device 2100 may include a connection terminal 2110, such as a socket or a slot or a connector. The data storage device 2200 may be mounted to the connection terminal 2110.

The data storage device 2200 may be configured in the form of a board, such as a printed circuit board. The data storage device 2200 may be referred to as a memory module or a memory card. The data storage device 2200 may include a controller 2210, a buffer memory device 2220, nonvolatile memory devices 2231 and 2232, a power management integrated circuit (PMIC) 2240, and a connection terminal 2250. For an embodiment, one or more of the nonvolatile memory devices 2231, 2232 represent the nonvolatile memory device 300 shown in FIG. 1.

The controller 2210 may control the general operations of the data storage device 2200. The controller 2210 may be configured in the same manner as the controller 1210 shown in FIG. 7.

The buffer memory device 2220 may temporarily store data to be stored in the nonvolatile memory devices 2231 and 2232. Further, the buffer memory device 2220 may temporarily store data read from the nonvolatile memory devices 2231 and 2232. The data temporarily stored in the buffer memory device 2220 may be transmitted to the host device 2100 or the nonvolatile memory devices 2231 and 2232 according to the control of the controller 2210.

The nonvolatile memory devices 2231 and 2232 may be used as storage media of the data storage device 2200.

The PMIC 2240 may provide power, inputted through the connection terminal 2250, to internal components of the data storage device 2200. The PMIC 2240 may manage the power of the data storage device 2200 according to the control of the controller 2210.

The connection terminal 2250 of the data storage device 2200 may be coupled to the connection terminal 2110 of the host device 2100. Through the connection terminal 2250, signals, such as commands, addresses, data, power, and so forth, may be transferred between the host device 2100 and the data storage device 2200. The connection terminal 2250 may be configured in various ways depending on an interface scheme between the host device 2100 and the data storage device 2200. The connection terminal 2250 may be disposed on any side of the data storage device 2200.

FIG. 9 shows a diagram illustrating a data processing system 3000 including a data storage device 3200, in accordance with an embodiment of the present teachings. Referring to FIG. 9, the data processing system 3000 may include a host device 3100 and the data storage device 3200.

The host device 3100 may be configured in the form of a board, such as a printed circuit board. Although not shown, the host device 3100 may include internal function blocks for performing the function of a host device.

The data storage device 3200 may be configured in the form of a surface-mounting type package. The data storage device 3200 may be mounted to the host device 3100 through solder balls 3250. The data storage device 3200 may include a controller 3210, a buffer memory device 3220, and a nonvolatile memory device 3230. For an embodiment, the nonvolatile memory device 3230 represents the nonvolatile memory device 300 shown in FIG. 1.

The controller 3210 may control the general operations of the data storage device 3200. The controller 3210 may be configured in the same manner as the controller 1210 shown in FIG. 7.

The buffer memory device 3220 may temporarily store data to be stored in the nonvolatile memory device 3230. Further, the buffer memory device 3220 may temporarily store data read out from the nonvolatile memory device 3230. The data temporarily stored in the buffer memory device 3220 may be transmitted to the host device 3100 or the nonvolatile memory device 3230, according to the control of the controller 3210.

The nonvolatile memory device 3230 may be used as a storage medium of the data storage device 3200.

FIG. 10 shows a diagram illustrating a a network system 4000 including a data storage device, in accordance with an embodiment of the present teachings. Referring to FIG. 10, the network system 4000 may include a server system 4300 and a plurality of client systems 4410, 4420, and 4430, which are coupled through a network 4500.

The server system 4300 may service data in response to requests from the plurality of client systems 4410, 4420, 4430. In one case, the server system 4300 may store the data provided from the plurality of client systems 4410, 4420, 4430. In another case, the server system 4300 may provide data to the plurality of client systems 4410, 4420, 4430.

The server system 4300 may include a host device 4100 and a data storage device 4200. The data storage device 4200 may be configured like the data storage device 100 shown in FIG. 4, the SSD 1200 shown in FIG. 7, the data storage device 2200 shown in FIG. 8, or the data storage device 3200 shown in FIG. 9.

FIG. 11 shows a block diagram illustrating a nonvolatile memory device 1102 included in a data storage device, in accordance with an embodiment of the present teachings. For an embodiment, the nonvolatile memory device 1102 represents the nonvolatile memory device 300 shown in FIG. 1. Referring to FIG. 11, the nonvolatile memory device 1102 may include a memory cell array 310, a row decoder 320, a data read/write block 330, a column decoder 340, a voltage generator 350, and a control logic 360.

The memory cell array 310 may include memory cells MC which are arranged at areas where word lines WL1 to WLm and bit lines BL1 to BLn intersect with each other.

The row decoder 320 may be coupled with the memory cell array 310 through the word lines WL1 to WLm. The row decoder 320 may operate according to the control of the control logic 360. The row decoder 320 may decode an address provided by and received from an external device (not shown). The row decoder 320 may select and drive the word lines WL1 to WLm, based on a decoding result. For instance, the row decoder 320 may apply a word line voltage, provided from the voltage generator 350, to the word lines WL1 to WLm.

The data read/write block 330 may be coupled with the memory cell array 310 through the bit lines BL1 to BLn. The data read/write block 330 may include read/write circuits RW1 to RWn corresponding to the bit lines BL1 to BLn, respectively. The data read/write block 330 may operate according to the control of the control logic 360. The data read/write block 330 may operate as a write driver or a sense amplifier according to an operation mode. For example, the data read/write block 330 may operate as a write driver, which stores data provided by the external device in the memory cell array 310 for a write operation. In another example, the data read/write block 330 may operate as a sense amplifier, which reads out data from the memory cell array 310 for a read operation.

The column decoder 340 may operate according to the control of the control logic 360. The column decoder 340 may decode an address provided by the external device. The column decoder 340 may couple the read/write circuits RW1 to RWn of the data read/write block 330 respectively corresponding to the bit lines BL1 to BLn with data input/output lines (or data input/output buffers), based on a decoding result.

The voltage generator 350 may generate voltages to be used in the internal operations of the nonvolatile memory device 1102. The voltages generated by the voltage generator 350 may be applied to the memory cells of the memory cell array 310. For example, a program voltage generated in a program operation may be applied to a word line of memory cells for which the program operation is to be performed. In another example, an erase voltage generated in an erase operation may be applied to a well area of memory cells for which the erase operation is to be performed. As a further example, a read voltage generated in a read operation may be applied to a word line of memory cells for which the read operation is to be performed.

The control logic 360 may control the general operations of the nonvolatile memory device 1102, based on control signals provided by and received from the external device. For example, the control logic 360 may control the read, write, and erase operations of the nonvolatile memory device 1102.

In various embodiments, described devices may be used in performing presented methods. Further, descriptions for some devices also apply to other devices. For brevity, descriptions are not repeated for each presented device. It will be understood by those skilled in the art that one device can operate in the same or a similar manner as another device.

While various embodiments have been described above, it will be understood by those skilled in the art that presented embodiments represent a subset of possible embodiments. Accordingly, the data storage device, the operating method thereof, and the nonvolatile memory device described herein should not be limited based on the described embodiments.

What is claimed is:

1. A nonvolatile memory device comprising:
a memory block;
a controller interface unit, wherein the nonvolatile memory device is configured to receive through the controller interface unit from a controller an erase command for performing an erase operation on the memory block; and
a memory control unit configured to perform the erase operation on the memory block,
wherein, when the nonvolatile memory device receives an erase suspend command through the controller interface unit from the controller during the erase operation, the memory control unit continues performing the erase operation up to a specified time.

2. The nonvolatile memory device of claim 1, wherein the memory control unit configured to continue the erase operation up to the specified time after the erase suspend command is received before suspending the erase operation in response to receiving the erase suspend command.

3. The nonvolatile memory device of claim 1, wherein the memory control unit configured to suspend the ease operation after the specified time.

4. The nonvolatile memory device of claim 1, wherein the memory control unit comprises a suspend information storage circuit which stores suspend information for an initial part of the erase operation that is performed up to the specified time before being suspended, wherein the memory control unit performs a remaining part of the erase operation, different from the initial part of the erase operation, based on the suspend information when the erase operation is resumed by the memory control unit.

5. The nonvolatile memory device of claim 1, wherein the memory control unit comprises a time determination circuit which selects the specified time from among one or more times calculated, according to one or more preset offset values, from a start time of the erase operation when an erase voltage is first applied for the erase operation.

6. The nonvolatile memory device of claim 5, wherein the time determination circuit selects as the specified time the next time from among the one or more calculated times to occur after the erase suspend command is received.

7. The nonvolatile memory device of claim 1, wherein the erase suspend command includes a write command.

8. The nonvolatile memory device of claim 1, wherein the erase suspend command includes a read command.

9. A data storage device comprising:
a controller; and
a nonvolatile memory device configured to perform an erase operation of data in response to receiving an erase command from the controller and configured to suspend the erase operation in response to receiving an erase suspend command from the controller,
wherein the nonvolatile memory device continues to perform the erase operation up to a specified time after receiving the erase suspend command.

10. The data storage device of claim 9, wherein the nonvolatile memory device configured to suspend the ease operation after the specified time.

11. The data storage device of claim 9, wherein the nonvolatile memory device comprises a memory control unit which controls the erase operation of data.

12. The data storage device of claim 11, wherein the memory control unit comprises a suspend information storage circuit which stores suspend information for an initial part of the erase operation that is performed up to the specified time, and wherein the nonvolatile memory device performs a remaining part of the erase operation, different from the initial part of the erase operation, based on the suspend information when the erase operation is resumed by the nonvolatile memory device.

13. The data storage device of claim 11, wherein the memory control unit comprises a time determination circuit which selects the specified time from among one or more times calculated, according to one or more preset offset values, from a start time of the erase operation when an erase voltage is first applied for the erase operation.

14. The data storage device of claim 13, wherein the time determination circuit selects as the specified time the next time from among the one or more calculated times to occur after the erase suspend command is received.

15. The data storage device of claim 9, wherein the erase suspend command includes a write command.

16. The data storage device of claim 9, wherein the erase suspend command includes a read command.

17. A method for operating a data storage device, the method comprising:
performing an erase operation for stored data in a nonvolatile memory device of the data storage device;
receiving, from a controller, an erase suspend command for suspending the erase operation being performed; and
determining a specified time up to which the erase operation continues to be performed after receiving the erase suspend command.

18. The method of claim 17 further comprising:
suspending the erase operation after continuing to perform the erase operation up to the specified time after receiving the erase suspend command.

19. The method of claim 17 further comprising:
resuming the erase operation after suspending the erase operation and performing a remaining part of the erase operation different from an initial part of the erase operation, wherein the initial part of the erase operation is performed before the specified time.

20. The method of claim 17 further comprising determining the specified time based on when the erase suspend command is received.

21. The method of claim 20, wherein determining the specified time comprises selecting a time from among one or more times calculated, according to one or more preset offset values, from a start time of the erase operation when an erase voltage is first applied for the erase operation.

22. The method of claim 21, wherein selecting a time from among one or more times comprises selecting as the specified time the next time of the one or more calculated times to occur after the erase suspend command is received.

23. The method of claim 17, wherein the erase suspend command includes a write command or a read command.

24. The method of claim 17 further comprising completing the erase operation in a plurality of parts, wherein at least two parts of the plurality of parts are separated in time by a delayed suspension of the erase operation, in response to receiving the erase suspend command, before resuming the erase operation.
